(19) United States
(12) Patent Application Publication
(10) Pub. No.: US 2024/0384127 A1
(43) Pub. Date: Nov. 21, 2024

(54) WATERBORNE ACRYLIC RESIN CONTAINING INORGANIC CROSSLINKING AGENT, LATEX CONTAINING THE SAME AND COATINGS FORMED FROM THE SAME

(71) Applicant: SWIMC LLC, Cleveland, OH (US)

(72) Inventors: Richard H. DUNN, Pataskala, OH (US); Brandon YOCUM, Powell, OH (US)

(21) Appl. No.: 18/661,800

(22) Filed: May 13, 2024

Related U.S. Application Data
(60) Provisional application No. 63/467,709, filed on May 19, 2023.

(51) Int. Cl. C09D 133/10; C09D 5/00; C09D 7/61

(52) U.S. Cl. CPC C09D 133/10; C09D 5/002; C09D 7/61

(57) ABSTRACT

A waterborne acrylic coating composition is provided, containing an acrylic resin having units formed from at least one (meth)acrylic unit containing monomer, wherein the acrylic resin has a plurality of reactive groups selected from hydroxyl groups, amino groups, and carboxyl groups; at least one inorganic multivalent crosslinking agent reactive with the plurality of reactive groups and, optionally, reactive with a surface coated by the waterborne acrylic coating composition; and water, along with coated substrates having at least a portion of their surface coated with the waterborne acrylic coating composition.

### CROSS REFERENCE TO RELATED APPLICATIONS

The present application is related to, and claims priority to, U.S. Provisional Application No. 63/467,709, filed May 19, 2023, the contents of which are herein incorporated by reference in their entirety.

### TECHNICAL FIELD

In general, the present invention relates to a waterborne acrylic coating composition containing an inorganic multivalent crosslinking agent, and coated substrates having the composition coated on at least a portion thereof.

### BACKGROUND OF THE INVENTION

The US paint and coatings industry includes more than 1,000 companies with combined annual sales in excess of $20 billion and continues to grow. Many coatings comprise a waterborne latex due to, for example, reduced emissions of volatile organic compounds (VOC), improved ease of clean-up and application, and reduced flammability when compared to solvent borne coatings. A waterborne latex at least includes a polymer dispersed in water. Upon applying a waterborne latex-based coating to a substrate, the water evaporates, and the remaining polymer coalesces to form a continuous, cured film on the substrate. The formulation of the waterborne latex-based coating may at least depend on the properties of the application substrate, the humidity and temperature of the application surface and surrounding environment, the VOCs emission standards to protect the environment, and the final cost and ease of application for the final customer.

A primer is a paint or coating product that allows finishing paint to adhere to a surface much better than if it were used alone. It is designed to adhere to surfaces and to form a binding layer that is better prepared to receive the paint. Compared to paint, a primer is not typically intended to be used as the outermost durable finish and can instead be engineered to have improved filling and binding properties with the material underneath. Sometimes this can be achieved by chemistry, and others by controlling the primer's physical properties such as its porosity, tackiness, and hygroscopicity.

Unfortunately, with some substrates (including, but not limited to, wood, metal, plastics, masonry or cementitious substrates, composite materials, and the like), primers and other coatings can have difficulties in achieving desired properties, such as better adhesion, reduced blocking, reduced efflorescence, and water permeability, just to name a few. Accordingly, a solution is needed to provide coatings with minimal adhesion loss with excellent block, efflorescence, and water permeability resistance, as well as other properties,

### SUMMARY OF THE INVENTION

Accordingly, one object of the present invention is to provide a coating system that contains an inorganic crosslinking agent capable of providing a latent crosslinking mechanism both internally in the coating and between the coating and a substrate onto which it is applied.

A further object of the invention is to provide a coating system that provides a robust passivation layer capable of minimal adhesion loss while providing one or more properties selected from excellent block, efflorescence, and water permeability resistance.

A further object of the invention is to provide a coating system using an ionic crosslinking mechanism that provides improved coating flexibility compared to covalent crosslinking mechanisms.

These and other objects of this invention, alone or in combination, have been satisfied by the discovery of a waterborne acrylic coating composition, comprising:
an acrylic resin having units formed from at least one (meth)acrylic unit containing monomer, wherein the acrylic resin has a plurality of reactive groups selected from hydroxyl groups, amino groups, and carboxyl groups,
at least one inorganic multivalent crosslinking agent reactive with the plurality of reactive groups, and optionally, reactive with a surface coated by the waterborne acrylic coating composition, and water; and coated substrates having the above coating system applied to at least a portion of a surface of the substrate.

### BRIEF DESCRIPTION OF THE DRAWING

A more complete appreciation of the invention and many of the attendant advantages thereof will be readily obtained as the same becomes better understood by reference to the following detailed description when considered in connection with the accompanying drawing, wherein:

FIG. 1 provides a photographic representation of adhesion testing results using coatings in accordance with embodiments of the present invention having different levels of inorganic multivalent crosslinking agent compared to a conventional acrylic primer composition having no inorganic multivalent crosslinking agent.

### DETAILED DESCRIPTION OF THE INVENTION

Embodiments of the present invention relate to a waterborne acrylic coating composition and a coated substrate coated on at least a portion of a surface of the substrate with the coating composition. In certain embodiments of the present invention, the waterborne acrylic coating composition comprises an acrylic resin having units formed from at least one (meth)acrylic unit containing monomer, wherein the acrylic resin has a plurality of reactive groups selected from hydroxyl groups, amino groups, and carboxyl groups; at least one inorganic multivalent crosslinking agent reactive with the plurality of reactive groups and, optionally, reactive with a surface coated by the waterborne acrylic coating composition; and water.

The recitation of a numerical range using endpoints includes all numbers subsumed within that range (e.g., 1 to 5 includes 1, 1.5, 2, 2.75, 3, 3.80, 4, 5, etc.).

To the extent that the terms “including”, “includes”, “having”, “has”, “with”, or variants thereof are used in the present application, such terms are intended to be inclusive in a manner similar to the term “comprising.” The singular forms “a”, “an” and “the” include plural referents unless the context clearly dictates otherwise. Additionally, the terms “a,” “an,” “the,” “at least one,” and “one or more” are used interchangeably. Thus, for example, a coating composition that contains “an” additive means that the coating composition can include “one or more” additives. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

The term “acrylic” as used herein includes (meth)acrylic acid, (meth)alkyl acrylate, (meth)acrylamide, (meth)acrylonitrile and their modified forms such as (meth)hydroxyalkyl acrylate. Throughout this document, the word fragment “(meth)acryl” refers to both “methacryl” and “acryl”. For example, (meth)acrylic acid refers to both methacrylic acid and acrylic acid, and methyl (meth)acrylate refers to both methyl methacrylate and methyl acrylate.

The term “aqueous” composition or dispersion herein means that particles are dispersed in an aqueous medium. An “aqueous medium” herein has a continuous phase of water that makes up at least 50 weight percent of the aqueous medium, wherein the remaining composition of the aqueous medium comprises particles and water-miscible compound(s) such as, for example, alcohols, glycols, glycol ethers, glycol esters, and the like.

Within the context of the present invention, the term “waterborne” is intended to mean that the polymeric components are in an aqueous medium. In certain embodiments, waterborne coatings provide one or more of the following advantages:
Low toxicity and flammability due to low VOC levels and low HAP emissions.
Lower cost than solvent-borne coatings and no additives, thinners, or hardeners are required in most cases
Less coating is required to cover the same surface area as compared to the use of solvent borne coating solutions
Application equipment can be readily cleaned with water or water-based solutions and do not require paint thinner, acetone, or methyl acetate (further environmentally friendly and user safety friendly)

The term “(co) polymer” as used herein includes both homopolymers (polymers containing units from a single monomer) and copolymers (polymers containing units from two or more different monomers), unless otherwise specifically stated.

The term “efflorescence” as used herein refers to the formation of a powdery deposit on the surface of a substrate, particularly on porous substrates in which mineral-like components in the substrate itself are prone to migrate on exposure to moisture, and particularly in alkaline substrates such as masonry or cementitious substrates. Efflorescence is basically a phenomenon that occurs when natural salts and minerals in materials such as brick, masonry, concrete and plastered surfaces dissolve in water present in the material. The water travels to the surface, evaporates and the mineral deposits are left as white chalky stains.

The term “glass transition temperature” or “Tg” in the present invention can be measured by various conventional techniques including, for example, differential scanning calorimetry (“DSC”) or calculation by using a Fox equation. DSC data and methods described herein are in accordance with ASTM D6604-00.

The term “(meth)acrylic acid” includes either or both of acrylic acid and methacrylic acid, and the term “(meth)acrylate” includes either or both of an acrylate and a methacrylate.

The term “multistage” when used with respect to a latex means the latex polymer was made using discrete charges of two or more monomers or was made using a continuously-varied charge of two or more monomers. Usually, a multistage latex will not exhibit a single Tg inflection point as measured using DSC. For example, a DSC curve for a multistage latex made using discrete charges of two or more monomers may exhibit two or more Tg inflection points. Also, a DSC curve for a multistage latex made using a continuously-varied charge of two or more monomers may exhibit no Tg inflection points. Occasionally when only one Tg inflection point is observed it may be difficult to determine whether the latex represents a multistage latex. In such cases a lower Tg inflection point may sometimes be detected on closer inspection, or the synthetic scheme used to make the latex may be examined to determine whether or not a multistage latex would be expected to be produced.

The term “single stage” when used with respect to a latex means the latex polymer was made using a single monomer or a non-varying charge of two or more monomers. Usually, a DSC curve for a single stage latex made using a single monomer charge or a non-varying charge of two monomers may exhibit only a single Tg inflection point.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

The term “dispersion” in the context of the present invention refers to the mixture of a dispersible polymer and a carrier. The term “dispersion” includes, but is not limited to, the term “solution.”

As used herein, the term “structural units,” also known as polymerized units, of the named monomer refers to the remnant of the monomer after polymerization, or the monomer in polymerized form.

The acrylic resin used in the present invention can be a single stage acrylic resin or multistage acrylic resin. In certain embodiments, the acrylic resin is a single stage acrylic resin. In certain embodiments, the acrylic resin is a two-stage acrylic resin.

In some embodiments of the present invention, the at least one (meth)acrylic unit containing monomer is an alkyl (meth)acrylate. In certain embodiments, the at least one (meth)acrylic unit containing monomer is a C₁-C₆ alkyl (meth)acrylate. In certain embodiments, the at least one (meth)acrylic unit containing monomer is a member selected from the group consisting of methyl methacrylate, methyl acrylate, ethyl methacrylate, ethyl acrylate, isopropyl acrylate, isopropyl methacrylate, n-propyl acrylate, n-propyl methacrylate, n-butyl acrylate, n-butyl methacrylate, isobutyl acrylate, isobutyl methacrylate, t-butyl acrylate, t-butyl methacrylate, n-pentyl acrylate, n-pentyl methacrylate, isopentyl acrylate, isopentyl methacrylate, neopentyl acrylate, neopentyl methacrylate, n-hexyl acrylate, n-hexyl methacrylate, isohexyl acrylate, isohexyl methacrylate, neohexyl acrylate, neohexyl methacrylate, cyclobutyl acrylate, cyclobutyl methacrylate, cyclopentyl acrylate, cyclopentyl methacrylate, cyclohexyl acrylate, and cyclohexyl methacrylate.

Without being bound by theory, and to which those familiar with the art will appreciate, the present invention uses a latent crosslinking approach through development of an organic-inorganic framework in conjunction with the acrylic resin. This latent crosslinked network is developed through the combination of the acrylic resin and at least one inorganic multivalent crosslinking agent. In embodiments of the present invention, the acrylic resin contains a plurality of reactive groups selected from hydroxyl groups, amino groups, and carboxyl groups. The at least one inorganic multivalent crosslinking agent is selected such that it is reactive with this plurality of reactive groups on the acrylic resin. The resulting latent crosslinked network helps to provide a robust coating with good passivating properties.

The present invention waterborne acrylic coating composition provides good substrate adhesion, with excellent blocking and efflorescence resistance, particularly when applied to composite building materials like wood, metal, plastics, masonry or cementitious substrates, wood, and composite building materials as well as substrates that have been previously coated. Use of ionic crosslinking in a waterborne acrylic resin coating composition over a covalent crosslinking mechanism also provides improved flexibility. The ionic bonds forming the crosslinking, while more susceptible to moisture and pH, provide a less rigid and more dynamic bond than those of permanent, rigid covalent crosslinked systems. This improved flexibility is particularly useful for creating resilient coatings and can maintain toughness thereby providing excellent adhesion and blocking resistance. Balancing crosslink density of the resin also allows for improved energy dissipation by providing resistance to brittle fracture while a sample is under load (i.e. compressive stress observed in blocking) or peel forces in adhesion testing. A material (coating) that is too brittle will often suffer catastrophic failure due to the fact it cannot easily plastically deform to effectively dissipate energy. A tough coating on the other hand can more readily dissipate energy through plastic deformation and survive to a higher ultimate failure stress. Increased crosslink density within an amorphous polymer will also help to reduce free volume and chain mobility. This reduced chain mobility benefits blocking by creating a stiffer/tougher coating. Efflorescence resistance also can be improved by reducing the amount of available carboxylic acid groups throughout the polymer backbone capable of acting as capillary conduits for soluble salts. Effectively blocking these hydrophilic channels with relatively insoluble ionic crosslinkers offers a supportive mechanism to minimizing permeability through tortuous path generation.

In certain embodiments, the at least one inorganic multivalent crosslinking agent is at least one member selected from the group consisting of Zn salts, Ca salts, Mg salts, Cu salts, Al salts, Mn salts, and Fe salts. In some embodiments, the at least one inorganic multivalent crosslinking agent is a member selected from Zn salts and Ca salts. In other embodiments, the at least one inorganic multivalent crosslinking agent is a Zn salt, and in certain embodiments it is a complexed Zn²⁺ salt. In other embodiments, the at least one inorganic multivalent crosslinking agent is a complex salt such as a Calcium/Zinc salt, or other multi-metal salt.

In some embodiments of the present invention, the at least one inorganic multivalent crosslinking agent is present in the waterborne acrylic coating composition in an amount of from 3 to 15% by weight based on total composition. In other embodiments, the at least one inorganic multivalent crosslinking agent is present in an amount of from 4 to 11% by weight based on total composition.

The ionic crosslinking in the present composition can involve crosslinking between polymer chains within the acrylic resin by way of the at least one inorganic multivalent crosslinking agent interacting with reactive groups (hydroxyl groups, amino groups, and/or carboxyl groups) located along the polymer chains. In certain embodiments, the at least one inorganic multivalent crosslinking agent also increases adhesion with the substrate by interacting with both the reactive groups on the polymer chains and reactive groups (hydroxyl groups, amino groups, and/or carboxyl groups) on the surface of the substrate being coated.

In some embodiments, the coating composition may further comprise at least one additional acrylic latex, wherein the at least one additional acrylic latex comprises an acrylic copolymer. In some embodiments, the acrylic copolymer comprises at least one (meth)acrylic unit containing monomer, and a further monomer which may be a (meth)acrylic unit containing monomer or an unsaturated monomer with no (meth)acrylic unit. In some embodiments, the coating composition may further comprise polymers of like synergies as the acrylic resin polymer, such as, for example, an epoxy, a urethane, or the like. The coating composition also generally can comprise numerous other additives and components, as are conventional or as otherwise may be found suitable in a coating composition. Examples of suitable additives may include but are not limited to any one or more of neutralizing agents, waxes, antifoaming agents, fillers, dyes, dispersants, surfactants, extenders, adhesion promoters, wetting agents, rheology modifiers, leveling agents, deflocculants, anti-blocking agents, antimicrobials such as mildewcides, fungicides, algaecides, and bactericides, other preservatives, thickeners, thixotropic agents, drying agents, anti-settling agents, rust inhibitors, flattening agents, pigments, hardeners, and combinations thereof. Suitable examples of the various optional components are presented herein and also disclosed in U.S. Pat. No. 8,993,110, the relevant portions of which are incorporated by reference herein.

The amount and number of coatings components in the coating composition may depend on the desired properties of the coating composition and the cured coating formed therefrom. The desired properties may depend on the material of the substrate, the use of the substrate, the surrounding environment during application of the coating composition, the surrounding environment that the coated substrate will be exposed to, and the like. In some embodiments, the coating components may be adjusted for aesthetics. For example, the coating composition may be formulated to achieve a desired finish and color of the cured coating formed therefrom. For example, the coating composition disclosed herein may coalesce on a warm substrate without coalescing agents to form a cured coating that is flat, satin, or eggshell, for example. A gloss finish may also be achieved but it is typically not a preferred finish when used as a primer or exterior coating.

Any suitable rheology modifier may be incorporated into a coating composition. Examples of polyurethane rheology modifiers may include but are not limited to nonionic, solvent-free, hydrophobically modified ethylene oxide urethane (HEUR) rheology modifiers and nonionic urethane rheology modifiers.

The coating composition can include any suitable surfactant. Examples of phosphate surfactants may include but are not limited to phosphate esters such as methyl phosphate, 2-ethylhexyl phosphate, decyl alcohol ethoxylated phosphate esters, lauryl alcohol ethoxylated phosphate esters, n-octyl phosphate, nonylphenol ethoxylated phosphate esters, octyl phenol ethoxylated phosphate esters, styrenated phenol ethoxylated phosphate esters, tridecyl alcohol ethoxylated phosphate esters, etc.

The coating composition can include one or more waxes. The one or more waxes can be any desired wax, depending on the properties desired. In certain embodiments, the one or more waxes include, but are not limited to, polyethylene waxes, oxidized polyolefin waxes, amide modified polyolefin waxes, paraffin waxes, and other hydrocarbon waxes. Such waxes can also provide an improvement in efflorescence properties of the coated substrate, particularly in the use of masonry or cementitious substrates.

Any suitable dispersant, such as any one or more of anionic dispersants, cationic dispersants, amphoteric dispersants, or nonionic dispersants may be used in the coating composition. Examples of dispersants may include but are not limited to 2-amino-2-methyl-1-propanol, pyrophosphates such as tetrapotassium pyrophosphate and tetrasodium pyrophosphate, tripolyphosphates such as potassium tripolyphosphate and sodium tripolyphosphate, etc. Any suitable wetting agents such as any one or more of anionic wetting agents, cationic wetting agents, amphoteric wetting agents, or nonionic wetting agents may be used. Any suitable deflocculant, such as sodium potassium tripolyphosphate, can be used.

The coating composition may, if desired, include one or more fillers or extenders. Examples of fillers may include but are not limited to sodium-potassium alumina silicates, calcium carbonate, and the like. When used, such fillers may be employed in any desired amount.

Useful antimicrobial additives include phosphates, zeolites, hydroxyapatites, organic acids, phenols, alcohols, qua-ternary ammonium compounds, additives containing metal ions such as ions of silver, zinc, and copper, etc.

Any suitable drying agent may be included in a coating composition. Examples of drying agents may include but are not limited to metal-based catalysts such as an iron-complex catalyst, a cobalt-free and metal-based catalyst, a zirconium-based catalyst, and the like. Preferably, suitable drying agents are free of VOCs.

One or more types of pigment may be included in a coating composition via any suitable technique, such as by adding raw pigment or a pigment vehicle during manufacture of the composition or by instilling a pigment at the point of sale. Examples of pigments may include but are not limited to azo pigments, anazurite, aluminum silicate, aluminum potassium silicate, aluminum paste, anthraquinone pigments, antimony oxide, barium metaborate, barium sulfate, cadmium sulfide, cadmium selenide, calcium carbonate, calcium metaborate, calcium meta-silicate, carbon black, chromium oxides, clay, copper oxides, copper oxychloride, dioxazine pigments, feldspar, hansa yellows azo pigments (some of which are listed above), benzimidazolones, iron oxides such as yellow and red iron oxides, isoindoline pigments, kaolinite, lithopone, magnesium silicates, metallic flakes, mica, napthol pigments such as napthol reds, nitroso pigments, nepheline syenite, perinone pigments, perylene pigments, polycyclic pigments, pyrropyrrol pigments, pthalocyanines such as copper pthalocyanine blue and copper pthalocyanine green, quinacri-dones such as quinacridone violets, quinophthalone pig-ments, silicates, sulfides, talc, titanium dioxide, ultramarine, zinc chromate, zinc oxide, and zinc phosphate. In addition, pearlescents, optical brighteners, ultraviolet stabilizers, and the like may be added to a coating composition. Titanium dioxide is a preferred pigment/whitening agent.

The waterborne acrylic resin of embodiments of the present invention can be prepared by any desired polymerization method, preferably by radical polymerization in an aqueous medium. In certain embodiments, the acrylic resin is prepared in the presence of the at least one inorganic multivalent crosslinking agent, while in other embodiments, the acrylic resin is first prepared, then combined with the at least one inorganic multivalent crosslinking agent. In other embodiments, the acrylic resin is prepared and stored, then combined with the at least one inorganic multivalent crosslinking agent (either as a solid or as a solution, suspension, or dispersion in an aqueous medium) and the two thoroughly mixed just prior to application of the coating composition to the substrate surface.

Upon applying the coating composition to a substrate, the composition will cure to form a cured coating. In some embodiments, initial curing periods span a period of, for example, less than four weeks from the time of application of a coating composition. In some embodiments, initial curing periods range from, for example, eighteen hours to four weeks, one day to three weeks, three days to two weeks, and one week to two weeks. Additionally, as mentioned above, curing times may be accelerated when the coated substrate is heated.

Once prepared, the coating composition may be dispensed into any desired storage container, such as a paint can. The coating composition then may be transported and stored, such as in a warehouse or on a store shelf.

In some embodiments, the disclosed coating composition is particularly useful and reliable when the application temperature of the coating composition can be controlled. In the context of the present invention, the application temperature refers to the temperature of the substrate to which the coating composition is being applied, the surrounding environment in which the coating composition is being applied, or both.

In some embodiments, the disclosed coating composition may form a reliable cured coating when formed over a substrate comprising, for example, masonry or cementitious substrates (including, but not limited to, cement board or fiber cement board), wood, metal, glass, plastic (e.g., a vinyl), paper, leather, fabric, ceramic, a composite material, the like, and any combination thereof. The coatings of embodiments of the present invention may have any desired dry film thickness, including but not limited to, a dry film thickness in a range from, for example, 0.3 mils to approximately 10 mils (approximately 7.6 micrometers to approximately 254 micrometers). In some other embodiments, the present invention coatings may have a dry film thickness in a range from, for example, 0.3 mils to approximately 2.2 mils (approximately 7.6 micrometers to approximately 55.9 micrometers).

In certain embodiments of the present invention, the present coating composition can be used as a primer on a substrate. In other embodiments of the present invention, the present coating composition can be used as a topcoat on a substrate. In still further embodiments of the present invention, the present coating composition can act as both primer and topcoat (i.e. a single coat covering composition) for a substrate. In yet another embodiment, the present coating composition may be applied to a previously coated substrate.

In certain embodiments, the present coating composition provides improvements in storage stability under industrial conditions.

In some embodiments, the coating composition may be applied to a substrate by way of roll coating, spray coating, curtain coating, dip coating, brush coating, or some other suitable coating process. In some embodiments, at least a portion of the substrate may be coated with the coating composition.

Additionally, the cured coating formed from the coating composition disclosed herein can sufficiently protect the substrates including, but not limited to, wood, metal, plastics, masonry or cementitious substrates, composite materials, and the like when exposed to various temperatures, weather conditions, and the like.

### Examples

The following examples are provided to illustrate the present invention and its advantages but should not be construed as limiting a scope of the invention.

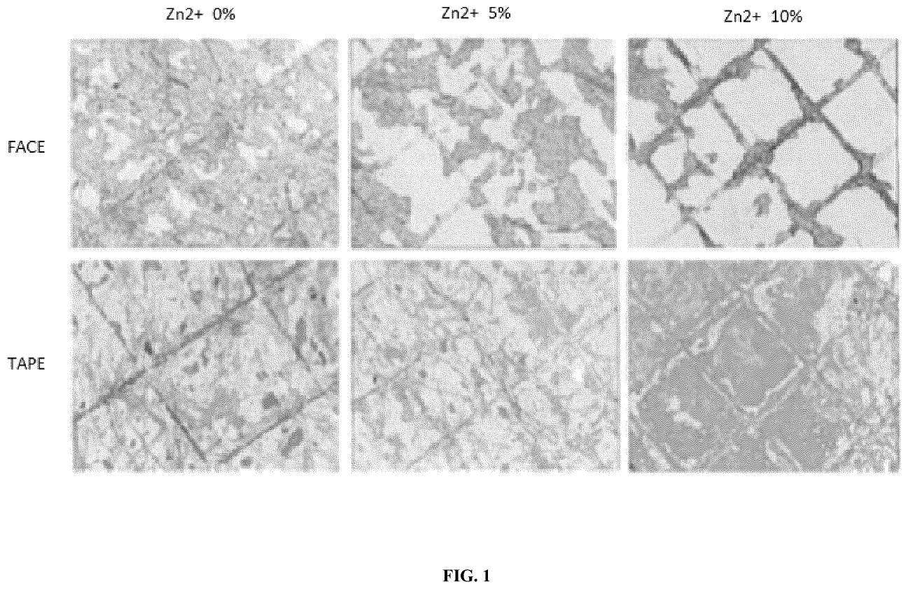

Adhesion of the waterborne acrylic coating composition of embodiments of the present invention was tested by coating a cementitious substrate with a conventional acrylic primer composition containing no inorganic multivalent crosslinking agent, and with compositions in accordance with the present invention containing 5% by weight of a complexed Zn2+ salt and 10% by weight of a complexed Zn2+ salt, respectively. The resulting coated cementitious substrate samples were tested using a 2 mm crosshatch tape testing method in accordance with ASTM 3359. The results are shown in FIG. 1, which clearly shows significant improvements in surface adhesion using the compositions of embodiments of the present invention compared to the conventional primer without the inorganic multivalent crosslinking agent.

Cobb testing (in accordance with ASTM D5795) was also performed on substrate samples coated with the conventional acrylic primer and substrate samples coated with embodiments of the present invention coating composition. The results showed that the present invention provides significant improvements in water permeability based on the Cobb test results compared to control.

Efflorescence properties of substrates coated with embodiments of the present invention was also tested and compared to the use of a control using a conventional acrylic primer containing no inorganic multivalent crosslinking agent. The test was performed in accordance with ASTM C₁₂₂₅ on a cementitious substrate. A visual inspection of where gloss change is apparent under ambient light helped to identify the efflorescence front due to wicking action within the substrate. These results showed minimal movement of the efflorescence front up the coated cementitious substrate using the waterborne acrylic coating composition of embodiments of the present invention compared to control.

Similarly, blocking tests in accordance with ASTM 02793 showed that the coatings of embodiments of the present invention provided significant improvements in blocking properties compared to coatings formed from conventional acrylic coating compositions that do not contain the inorganic multivalent crosslinking agent.

The following are non-limiting examples of some embodiments of the present invention:

Embodiment 1. A waterborne acrylic coating composition, comprising:
an acrylic resin having units formed from at least one (meth)acrylic unit containing monomer, wherein the acrylic resin has a plurality of reactive groups selected from hydroxyl groups, amino groups, and carboxyl groups, at least one inorganic multivalent crosslinking agent reactive with the plurality of reactive groups and, optionally, reactive with a surface coated by the waterborne acrylic coating composition, and water.

Embodiment 2. The waterborne acrylic coating composition of Embodiment 1, wherein the acrylic resin is a single stage acrylic resin.

Embodiment 3. The waterborne acrylic coating composition of Embodiment 1, wherein the acrylic resin is a multi-stage resin.

Embodiment 4. The waterborne acrylic coating composition of any one of Embodiments 1-3, wherein the at least one (meth)acrylic unit containing monomer is at least one alkyl (meth)acrylate.

Embodiment 5. The waterborne acrylic coating composition of any one of Embodiments 1-4, wherein the at least one (meth)acrylic unit containing monomer is at least one C₁-C₆ alkyl (meth)acrylate.

Embodiment 6. The waterborne acrylic coating composition of any one of Embodiments 1-5, wherein the at least one (meth)acrylic unit containing monomer is the at least one member selected from the group consisting of methyl methacrylate, methyl acrylate, ethyl methacrylate, ethyl acrylate, isopropyl acrylate, isopropyl methacrylate, n-propyl acrylate, n-propyl methacrylate, n-butyl acrylate, n-butyl methacrylate, isobutyl acrylate, isobutyl methacrylate, t-butyl acrylate, t-butyl methacrylate, n-pentyl acrylate, n-pentyl methacrylate, isopentyl acrylate, isopentyl methacrylate, neopentyl acrylate, neopentyl methacrylate, n-hexyl acrylate, n-hexyl methacrylate, isohexyl acrylate, isohexyl methacrylate, neohexyl acrylate, neohexyl methacrylate, cyclobutyl acrylate, cyclobutyl methacrylate, cyclopentyl acrylate, cyclopentyl methacrylate, cyclohexyl acrylate, and cyclohexyl methacrylate.

Embodiment 7. The waterborne acrylic coating composition of any one of Embodiments 1-6, wherein the at least one inorganic multivalent crosslinking agent is at least one member selected from the group consisting of Zn salts, Ca salts, Mg salts, Cu salts, Al salts, Mn salts, and Fe salts.

Embodiment 8. The waterborne acrylic coating composition of any one of Embodiments 1-7, wherein the at least one inorganic multivalent crosslinking agent is a member selected from Zn salts and Ca salts.

Embodiment 9. The waterborne acrylic coating composition of any one of Embodiments 1-8, wherein the at least one inorganic multivalent crosslinking agent is a Zn salt.

Embodiment 10. The waterborne acrylic coating composition of Embodiment 9, wherein the Zn salt comprises a complexed Zn2+ salt.

Embodiment 11. The waterborne acrylic coating composition of any one of Embodiments 1-10, wherein the at least one inorganic multivalent crosslinking agent is present in the composition in an amount of from 3-15% by weight based on total composition.

Embodiment 12. The waterborne acrylic coating composition of any one of Embodiments 1-11, further comprising at least one additional acrylic latex.

Embodiment 13. The waterborne acrylic coating composition of claim 12, wherein the at least one additional acrylic latex comprises an acrylic copolymer.

Embodiment 14. The waterborne acrylic coating composition of Embodiment 13, wherein the acrylic copolymer is a copolymer of at least one (meth)acrylic unit containing monomer, and a further monomer which may be a (meth)acrylic unit containing monomer or an unsaturated monomer with no (meth)acrylic unit.

Embodiment 15. The waterborne acrylic coating composition of any one of Embodiments 1-14, further comprising at least one member selected from the group consisting of plasticizers, thickeners, defoamers, surfactants, dispersants, matting agents, solvents, antimicrobial agents, pigments, hardeners, pH adjusters, waxes, and combinations thereof.

Embodiment 16. The waterborne acrylic coating composition of any one of Embodiments 1-15, wherein the composition is a primer composition.

Embodiment 17. The waterborne acrylic coating composition of any one of Embodiments 1-16, wherein the composition is a topcoat composition.

Embodiment 18. A coated substrate, comprising the waterborne acrylic coating composition of any one of Embodiments 1-17, applied to at least a portion of a substrate.

Embodiment 19. The coated substrate of Embodiment 18, wherein the substrate comprises at least one member selected from the group consisting of wood, metal, glass, plastic, paper, leather, fabric, ceramic, cement, cement board, composite material, and any combination thereof.

Embodiment 20. The coated substrate of one of Embodiments 18 or 19, wherein the substrate is a member selected from the group consisting of cement and cement board.

Embodiment 21. The coated substrate of any one of Embodiments 18-20, wherein the coating composition is applied to the substrate by a method selected from the group consisting of roll coating, spray coating, curtain coating, dip coating, and brush coating.

Embodiment 22. The coated substrate of any one of Embodiments 18-21, wherein the coating composition is crosslinked internally by the at least one inorganic crosslinking agent, and wherein the coating composition is bonded to reactive groups on a surface of the substrate through the at least one inorganic crosslinking agent.

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that are not different from the literal language of the claims, or if they include equivalent structural elements with insubstantial differences from the literal language of the claims.

Additional modifications and variations of the present invention are possible in light of the above teachings. It is therefore to be understood that within the scope of the appended claims, the invention may be practiced otherwise than as specifically described herein.

What is claimed is:

1. A waterborne acrylic coating composition, comprising:
an acrylic resin having units formed from at least one (meth)acrylic unit containing monomer, wherein the acrylic resin has a plurality of reactive groups selected from hydroxyl groups, amino groups, and carboxyl groups, at least one inorganic multivalent crosslinking agent reactive with the plurality of reactive groups and, optionally, reactive with a surface coated by the waterborne acrylic coating composition, and water.

2. The waterborne acrylic coating composition of claim 1, wherein the acrylic resin is a single stage acrylic resin.

3. The waterborne acrylic coating composition of claim 1, wherein the acrylic resin is a multi-stage resin.

4. The waterborne acrylic coating composition of claim 1, wherein the at least one (meth)acrylic unit containing monomer is at least one alkyl (meth)acrylate.

5. The waterborne acrylic coating composition of claim 1, wherein the at least one (meth)acrylic unit containing monomer is at least one C₁-C₆ alkyl (meth)acrylate.

6. The waterborne acrylic coating composition of claim 1, wherein the at least one (meth)acrylic unit containing monomer is the at least one member selected from the group consisting of methyl methacrylate, methyl acrylate, ethyl methacrylate, ethyl acrylate, isopropyl acrylate, isopropyl methacrylate, n-propyl acrylate, n-propyl methacrylate, n-butyl acrylate, n-butyl methacrylate, isobutyl acrylate, isobutyl methacrylate, t-butyl acrylate, t-butyl methacrylate, n-pentyl acrylate, n-pentyl methacrylate, isopentyl acrylate, isopentyl methacrylate, neopentyl acrylate, neopentyl methacrylate, n-hexyl acrylate, n-hexyl methacrylate, isohexyl acrylate, isohexyl methacrylate, neohexyl acrylate, neohexyl methacrylate, cyclobutyl acrylate, cyclobutyl methacrylate, cyclopentyl acrylate, cyclopentyl methacrylate, cyclohexyl acrylate, and cyclohexyl methacrylate.

7. The waterborne acrylic coating composition of claim 1, wherein the at least one inorganic multivalent crosslinking agent is at least one member selected from the group consisting of Zn salts, Ca salts, Mg salts, Cu salts, Al salts, Mn salts, and Fe salts.

8. The waterborne acrylic coating composition of claim 1, wherein the at least one inorganic multivalent crosslinking agent is a member selected from Zn salts and Ca salts.

9. The waterborne acrylic coating composition of claim 1, wherein the at least one inorganic multivalent crosslinking agent is a Zn salt.

10. The waterborne acrylic coating composition of claim 9, wherein the Zn salt comprises a complexed Zn²⁺ salt.

11. The waterborne acrylic coating composition of claim 1, wherein the at least one inorganic multivalent crosslinking agent is present in the composition in an amount of from 3-15% by weight based on total composition.

12. The waterborne acrylic coating composition of claim 1, further comprising at least one additional acrylic latex.

13. The waterborne acrylic coating composition of claim 12, wherein the at least one additional acrylic latex comprises an acrylic copolymer.

14. The waterborne acrylic coating composition of claim 13, wherein the acrylic copolymer is a copolymer of at least one (meth)acrylic unit containing monomer, and a further monomer which may be a (meth)acrylic unit containing monomer or an unsaturated monomer with no (meth)acrylic unit.

15. The waterborne acrylic coating composition of claim 1, further comprising at least one member selected from the group consisting of plasticizers, thickeners, defoamers, surfactants, dispersants, matting agents, solvents, antimicrobial agents, pigments, hardeners, pH adjusters, waxes, and combinations thereof.

16. The waterborne acrylic coating composition of claim 1, wherein the composition is a primer composition.

17. The waterborne acrylic coating composition of claim 1, wherein the composition is a topcoat composition.

18. A coated substrate, comprising the waterborne acrylic coating composition of claim 1, applied to at least a portion of a substrate.

19. The coated substrate of claim 18, wherein the substrate comprises at least one member selected from the group consisting of wood, metal, glass, plastic, paper, leather, fabric, ceramic, cement, cement board, composite material, and any combination thereof.

20. The coated substrate of claim 18, wherein the substrate is a member selected from the group consisting of cement and cement board.

21. The coated substrate of claim 18, wherein the coating composition is applied to the substrate by a method selected from the group consisting of roll coating, spray coating, curtain coating, dip coating, and brush coating.

22. The coated substrate of claim 18, wherein the coating composition is crosslinked internally by the at least one inorganic crosslinking agent, and wherein the coating composition is bonded to reactive groups on a surface of the substrate through the at least one inorganic crosslinking agent.
